(19) United States
(12) Patent Application Publication
(10) Pub. No.: US 2014/0332679 A1
(43) Pub. Date: Nov. 13, 2014

(54) Apparatus and Method Relating to an Improved Mass Spectrometer

(71) Applicant: IONOPTIKA LIMITED, Hampshire (GB)

(72) Inventors: Paul William Miles Blenkinsopp, Hampshire (GB); Andrew Mark Barber, Hampshire (GB)

(21) Appl. No.: 14/276,147

(22) Filed: May 13, 2014

(30) Foreign Application Priority Data
May 13, 2013 (GB) 1308505.5

(51) Int. Cl. H01J 49/10; H01J 49/00

(52) U.S. Cl. CPC H01J 49/10; H01J 49/0031
USPC 250/282; 250/281

(57) ABSTRACT

The present disclosure provides a mass spectrometer including means for producing a primary beam of ions for bombarding a sample under vacuum and a detector for detecting a secondary beam of ions released from the sample. The primary beam of ions includes a gaseous mixture of a cluster forming gas and one or more hydrogen-rich hydrocarbons.

### RELATED APPLICATIONS

This application claims priority to and the benefit of GB Application No. 1308505.5, filed on May 13, 2013, which is hereby expressly incorporated by reference in its entirety.

### FIELD OF THE DISCLOSURE

The present disclosure relates to an improved mass spectrometer and an analytical method associated therewith.

### BACKGROUND

In 1910, the British physicist J. J. Thomson observed that positive ions and neutral atoms were released from a solid surface when bombarded with ions. Later, in 1949, improvements in vacuum pumps and associated technologies enabled the first prototype experiments on Secondary Ion Mass Spectrometry (SIMS) to be carried out by Herzog and Viehböck at the University of Vienna in Austria. Since the earliest days, the potential for SIMS to be a very powerful analytical technique has been recognised but has not yet realised its fullest potential. In the intervening years to now, the SIMS technique has expanded to encompass many different and useful methods of material analysis, many of which are not achievable by other analytical methods. These include 2 dimensional chemical mapping or imaging, depth profiling and more recently the capability to obtain detailed chemical and compositional information from biological and bio-chemical materials. The range of probes of the material has also increased, starting from elementary ion probes, such as argon or oxygen, but now including large molecular clusters such as C60, giant gas clusters and laser ablation. Other improvements to the SIMS technique have included improved mass and spatial resolution, the possibility to measure non-ionized material removed from the sample by post ionisation, the so called Secondary Neutral Mass Spectrometry (SNMS) that permits analysis of the removed material in a mass spectrometer and the ubiquitous advances in computing technology that has led to a vast array of instrument control, data capture and analysis facilities.

Several methods of analysis in a mass spectrometer are used for SIMS. These include mass separation by using powerful electromagnets, the so called Magnetic Sector instrument, mass separation by the application of Radio Frequency (RF) electric fields, the so called Quadrupole and the Ion Trap, and the separation of masses by their arrival time at a detector, the technique known as Tine of Flight (ToF). The Time of Flight SIMS technique is particularly well suited to analysis of organic samples, because it can simultaneously detect ions from a wide mass range, allowing for a very high efficiency in detecting a large proportion of secondary ions. FIG. 1 shows a typical arrangement inside the vacuum chamber of a ToF-SIMS instrument. The sample to be analyzed is mounted on a holder (1) which is introduced into a vacuum chamber (2) and secured on a motion stage (3). A primary ion beam (4) is generated by an ion source (not shown), accelerated and directed at the sample. The vacuum housing (5) that encloses the ion source is shown in part. The impact of primary ions on the sample surface causes secondary ions to be ejected from the sample and these are captured and accelerated by the extraction optics (6). These ions travel in the direction (7) to enter a time of flight analyzer (not shown) and ultimately to hit an ion detector. The vacuum housing (8) for the analyzer is shown in part. The time of flight analyzer can be simply a flight tube, but may also contain other ion-optical components such as energy-compensating devices, focusing or alignment devices or pulsing devices.

During the latter part of the twentieth century SIMS developed largely as a technique for elemental analysis. Atomic or small molecular ion beams, made of species such as Ga⁺, Cs⁺, O₂⁺, Ar⁺, were used as primary ion beams to stimulate emission of secondary ions. Such primary beams cause too much damage at the sample surface and too much fragmentation of emitted material to produce large molecular secondary ions. So, the technique was limited to elemental analysis or, at best detection of small molecular fragments. Ion beams of different species offered a range of features, suiting them to different variants of SIMS analysis. For example, a small probe size is advantageous for high spatial resolution imaging or a good beam shape is advantageous for depth profiling. Oxygen beams enhance yields of positive secondary ions, whilst caesium beams enhance negative secondary ion yields.

Around the year 2000, cluster ion beams were introduced to extend the mass range of the SIMS technique and to enable organic analysis. The earliest cluster ion primary beams were small metallic clusters produced by a liquid metal ion source (LMIS), for instance gold clusters of 2 or 3 gold atoms (N. Davies, D. E. Weibel; NP. Lockyer, P. Blenkinsopp, R. Hill, J C. Vickerman Appl. Surf. Sci. 203-204 (2003) 223-227), followed by similar sources using alternative metals such as bismuth. Such beams were able to release secondary ions of whole organic molecules and large fragments, but they cause too much damage to underlying sample to continue analysis beyond the top monolayer or so of the sample surface, when used by themselves. The first cluster beam that was routinely capable of analysing a polymer or organic sample whilst etching through its bulk was the C₆₀ ion beam (D. Weibel, S. Wong, N. Lockyer, P. Blenkinsopp, R. Hill, J C. Vickerman, Anal. Chem. 75 (2003) 1754). C₆₀ was found to produce higher yields of organic molecules with much reduced damage to the underlying sample. This is because, with 60 atoms in its cluster, the beam energy is dissipated only in the top few layers of the sample, releasing intact secondary ions by shaking them from the surface surrounding each impact site and leaving underlying chemistry largely undamaged.

The next significant development in ion beams for organic SIMS was the Gas Cluster Ion Beam (GCIB). Cluster formation through a supersonic expansion was first studied by Becker et al. for thermonuclear fuel applications (E. W. Becker, K. Bier, W. Henkes, Z Phys. 146 (1956) 6511). Clusters are typically formed by creating an adiabatic expansion of a gas from a high pressure region into a low pressure region through a small orifice. As the gas expands, it cools, and clusters are formed. These clusters can range from 2 atoms up to tens of thousands of atoms. By ionising the clusters, it is possible to produce charged clusters, which can then be mass filtered if required, and accelerated to produce an ion beam that can be directed onto a sample. Cluster beams can deliver a large amount of the cluster material to the sample at relatively low energies per atom within the cluster. This has opened out new applications using them for cleaning surfaces, reducing surface roughness, and depositing material on the surface.

Over the past decade, there has been much work done with argon gas cluster ion beams for use in modifying surface properties of materials (Isao Yamada, Jiro Matsuo, Noriaki Toyoda, Norihisa Hagiwara, Nucl. Instr. and Meth. B 161-163 (2000) 980-985). More recently, argon gas cluster ion beams have been used for sputtering material in SIMS, where they have been shown to be able to sputter large organic molecules with less fragmentation and damage then occurs when atomic ion beams are used (Sadia Rabbani, Andrew M. Barber, John S. Fletcher, Nicholas P. Lockyer, and John C. Vickerman, Anal. Chem. 2011, 83, 3793-3800).

In present day organic SIMS analysis, the C₆₀ and argon cluster beams are used as low-damage beams either for etching away layers of sample between analyzes by another ion beam, or for direct SIMS analysis. The use of these cluster beams has opened out the use of SIMS in analysis of polymers and biological material. However, there is a remaining problem of sensitivity to large molecular species which may be present in very small concentrations in the sample. This problem arises from the need to detect such large molecules from within a very small area of the sample. One of the most promising fields for organic SIMS is in the imaging of cells, tissue, or other structures with very fine features. The imaging technique usually proceeds by scanning the primary ion beam across the sample in steps, thus acquiring a mass spectrum from a series of pixels. With a suitable scan pattern, a complete image of a sample area is built up, with a mass spectrum for each pixel in the image. With present day ion beams (C₆₀ and argon clusters) detection of important organic molecules, such as lipids or peptides, becomes unsatisfactory when the pixel size decreases below a few square microns. The number of molecules available for interrogation within such a small area is limited and the technique may need to be sensitive to less than an attomole presence of a particular molecule in each pixel. ToF SIMS instrumentation has been improved to give high transmission and dynamic range in order to maximise sensitivity; there remains little room for improvement through instrument development. However, there is an opportunity to achieve significantly higher sensitivity by increasing the yield of secondary ions. Most of the material that is sputtered from the surface leaves as neutral molecules or fragments. By causing the ionisation of more of this material, sensitivity in organic analysis would be increased proportionately.

A cluster primary ion beam has been developed and is described herein that provides a surprisingly good enhancement in ion yields by taking advantage of the high content of hydrogen atoms in hydrocarbon molecules. In our disclosure, the beam can be focused to less than 5 microns, allowing the use of the beam for analysis at high spatial resolution or for precise co-targeting of an analysis point with another beam performing analysis. Organic samples are often frozen to near liquid nitrogen temperature for SIMS analysis in order to preserve the hydrated structures of the samples, for instance in analysis of cells or tissues, or to stabilise chemistry under ion bombardment, as in some multi-interface polymer analysis. A broad cluster ion beam is undesirable for frozen samples owing to the danger of frost formation over the sample surface from the excess of hydrocarbon molecules reaching the sample.

### SUMMARY OF THE DISCLOSURE

In accordance with one aspect of the present disclosure, there is provided a mass spectrometer including means for producing a primary beam of ions for bombarding a sample under vacuum; and a detector for detecting a secondary beam of ions released from the sample; wherein the primary beam of ions includes a gaseous mixture of a cluster forming gas and one or more hydrogen-rich hydrocarbons.

The one or more hydrogen-rich hydrocarbons may be selected from: methane, ethane, propane or butane.

The cluster forming gas may be selected from: helium, argon, neon, xenon, carbon dioxide or nitrogen.

The primary beam of ions may contain between 2 and 20,000 molecules.

The primary beam of ions may be produced by adiabatic expansion of the gaseous mixture. In particular, the gaseous mixture may be adiabatically expanded by passing from a high pressure region to a lower pressure region through a nozzle. The lower pressure region may have a pressure of 1 mBar or less.

The mass spectrometer may be configured to accelerate the primary beam of ions to an energy between 1 keV and 40 keV prior to bombarding the sample.

The mass spectrometer may further comprise means for producing an auxiliary beam of ions for bombarding the sample, where the auxiliary beam of ions comprises different species to those of the primary beam of ions.

The primary beam of ions and the auxiliary beam of ions may be arranged to simultaneously bombard the sample.

Alternatively, the primary beam of ions and the auxiliary beam of ions may be arranged to alternately bombard the sample.

The detector may be arranged to detect a secondary beam of ions released from the sample due to bombardment of the sample by the primary beam of ions.

The detector may be arranged to detect a secondary beam of ions released from the sample due to bombardment of the sample by the auxiliary beam.

The mass spectrometer may further comprise a sampling device arranged to create pulses of the secondary beam of ions.

In the primary beam of ions is arranged to irradiate the sample.

The primary beam of ions may be arranged to deliver protons to the sample.

The primary beam of ions may be focused onto the sample with a spot size of 10 micrometres or less.

The primary beam of ions may be focused onto the sample with a spot size of 5 micrometres or less.

In accordance with another aspect of the present disclosure, there is provided an analytical method whereby a primary beam of ionized clusters formed from a gaseous mixture of a gas known to form clusters readily and one or more hydrogen-rich hydrocarbons is used to bombard a sample under vacuum either i) as a secondary ion mass (SIMS) analysis beam, or ii) as a sputter beam during, or in rapid alternation with, bombardment by an auxiliary beam that is acting as a SIMS analysis beam, or iii) as a dosing beam during, or in rapid alternation with, bombardment by an auxiliary beam that is acting as a SIMS analysis beam, in order to produce an enhanced signal of secondary ions at the detector of a SIMS analyzer, thereby enhancing the chemical information obtained from the sample.

In accordance with another aspect of the present disclosure, there is provided an analytical method, including bombarding a sample under vacuum using a primary beam of ionized clusters formed from a gaseous mixture of a gas known to form clusters readily and one or more hydrogen-rich hydrocarbons; and producing an enhanced signal of secondary ions at the detector of a secondary ion mass spectrometry (SIMS) analyzer, thereby enhancing the chemical information obtained from the sample; wherein the primary beam is used as i) as a secondary ion mass (SIMS) analysis beam, or ii) as a sputter beam during, or in rapid alternation with, bombardment by an auxiliary beam that is acting as a SIMS analysis beam, or iii) as a dosing beam during, or in rapid alternation with, bombardment by an auxiliary beam that is acting as a SIMS analysis beam. The one or more hydrogen-rich hydrocarbons may be a gas selected from: methane, ethane, propane or butane.

The gas known to form clusters may be selected from: helium, argon, neon, xenon, carbon dioxide or nitrogen.

The primary beam of of ionized clusters may be selected to have a desired cluster size range between 2 and 20,000 molecules by tuning of one or more of gas cluster source conditions, ionizer conditions, or a mass filter.

The analytical method may include focusing and rastering the primary beam of ionized clusters on the sample, allowing a spectral image of the secondary ions to be generated from the sample area being bombarded.

The beam of ionized clusters may be produced by expansion of the gaseous mixture from a region of higher pressure through a nozzle into a region of lower pressure which is less than 1 mBar, then ionized and then accelerated to an energy in the range from 1 keV to 40 keV.

The area being bombarded may be repeatedly etched by the ionized cluster beam, eroding away the surface in layers, with the secondary ion data for each layer taken such that chemical information for different depths below the surface is acquired.

The auxiliary beam of ions may comprise a different species to those of the primary beam.

Secondary ions produced by bombardment of the sample with the primary beam may not collected, but secondary ions produced by bombardment of the sample with the auxiliary beam after bombardment of the sample with the primary beam may be collected and analyzed.

The primary beam may have a velocity component normal to a surface of the sample that is sufficiently low so as to produce substantially no secondary ions.

Secondary ions produced by bombardment of the sample with the primary beam may be collected and analyzed, and secondary ions produced by bombardment of the sample with the auxiliary beam after bombardment of the sample with the primary beam may also be collected and analyzed.

The beam of ionized clusters may be pulsed on/off during the analysis.

In one aspect, the present disclosure relates to an analytical method whereby a beam of ionized clusters is used to bombard a sample under vacuum either as a secondary ion mass spectrometry (SIMS) analysis beam, or as a dosing beam during, or in rapid alternation with, bombardment by another beam that is acting as a SIMS analysis beam. SIMS is a technique wherein a sample is analyzed by bombarding a sample, contained in a vacuum chamber, with a beam of primary ions (analysis beam), those primary ions having sufficient energy to sputter secondary ions from the sample. Such secondary ions are collected and transmitted to a mass analyzer to give a mass spectrum of a small area of the sample. Cluster beams such as C₆₀ or giant argon clusters are currently used in SIMS analysis of organic samples, either to directly produce the secondary ions, or to sputter material from the surface revealing a new, fresh surface to be analyzed by a second beam. An ion source has been built that delivers a beam of cluster ions formed from a mixture of a gas which is known to form clusters and a hydrocarbon gas. Higher yields of molecular secondary ions have been demonstrated when using this cluster beam, in comparison with established ion beams, thereby enhancing the chemical information obtained from the sample.

### BRIEF DESCRIPTION OF THE DRAWINGS

Embodiments of the disclosure are further described hereinafter with reference to the accompanying drawings, in which:

FIG. 1 shows a schematic view of part of a prior art ToF-SIMS instrument;

FIG. 2 shows a schematic view of a part of an apparatus in accordance with an embodiment of the present disclosure; and

FIG. 3 shows a plot of SIMS signals for known fragments of trehalose in counts of secondary ions per picoampere of primary ion beam current.

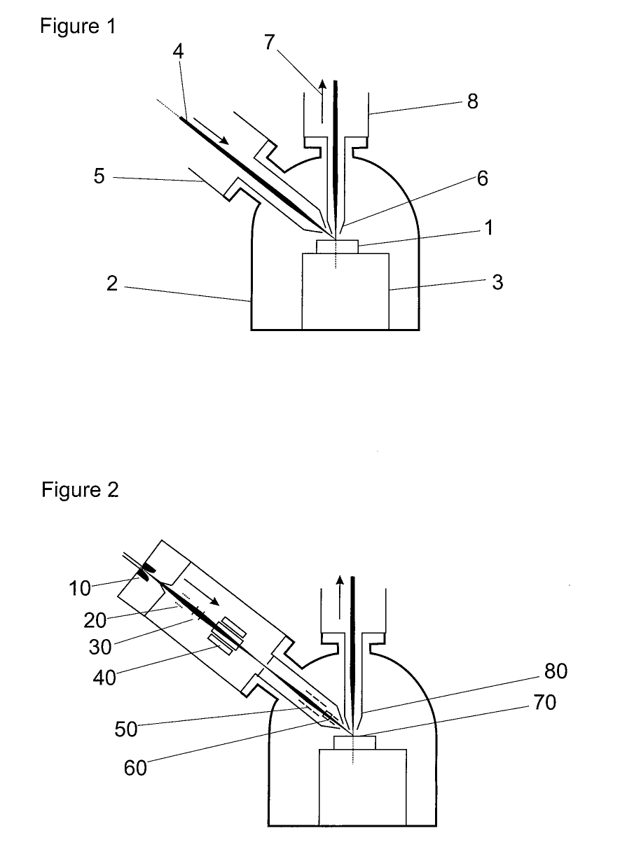

### DESCRIPTION OF THE DISCLOSURE

The present disclosure is a cluster primary ion beam formed from a mixture of hydrocarbon and inert gases which can be used to irradiate a sample. We have demonstrated elevated secondary ion yields for use of a cluster ion beam, generated from a mixture of argon gas and methane gas, with organic samples. We expect the increased ion yields to be also observed with cell and tissue samples, including frozen ones, polymers and inorganic samples. We expect similar enhancement of secondary ion yields with other hydrocarbons, such as ethane, propane or butane, in the mixture, or with alternative inert gases, such as helium, neon or nitrogen, in the mixture. The clusters, generated by adiabatic gas expansion and subsequent ionisation by electron bombardment, were selected within a range between 112 atomic mass units and 56,000 atomic mass units. FIG. 2 shows the setup of the apparatus used. Clusters were generated by expansion of the mixed gases through a nozzle (10) and then the clusters were ionized in an electron bombardment source (20). The ionized clusters were accelerated to 20 keV in transit through the extraction optics (30) before passing through a mass filter (40) which defines the cluster size distribution to be used. An electrostatic lens (50) focused the beam and electrostatic deflection plates (60) rastered the beam over the sample surface. In principle, the beam can be focused to a spot size of less than 5 microns with this optical system. The focused cluster beam impacted on the sample (70). Secondary ions from the sample were collected into the secondary ion extraction optics (80) and transmitted to the mass analyzer (not shown).

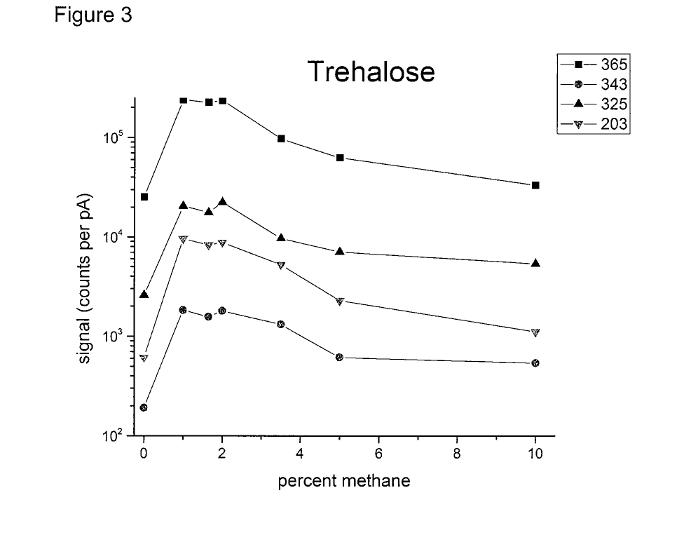

The resulting ion yields have been shown, and hence the sensitivity of the SIMS instrumentation, is substantially higher with this beam compared with the yields from pure argon cluster beam bombardment. FIG. 3 shows plots of SIMS signals for known fragments of trehalose, an α-linked disaccharide. The signal, expressed in counts of secondary ions per picoampere of primary ion beam current, is plotted against percent of methane in a mixture of methane and argon gases used to feed the cluster formation nozzle. The signals for all four molecular weights are increased with methane included in the clusters with between 8-fold and 25-fold secondary ion enhancement for methane levels between 1% and 2%. Nominal mass 343 is the M+H^{±} ion from trehalose and this shows the highest signal enhancement. Nominal mass 365 is the M+Na⁺ ion, with a 10-fold increase in signal. This indicates that charge exchange processes occur in the sample after bombardment, with sodium adducting to the trehalose molecule most probably giving an electron to a proton in the process. Such charged species will remain available for some time after the cluster beam bombardment and hence the beam is useful both as a primary analysis beam and as a dosing beam used in conjunction with another beam as the primary analysis beam.

A significant drawback of the ToF-SIMS technique with existing ion beams is an inability to quantify concentrations of different substances in the sample, owing to large variations in ion yield between substances. A major cause of this is differences in affinity to protonation in organic molecules. By saturating the analysis location with protons and overcoming the variations in protonation, our disclosure will facilitate more quantitative analysis. It was also noted that satisfactory vacuum conditions were sustained during analyzes and there was no unintended modification of the sample chemistry.

The analysis was undertaken using an average cluster size of 4000 units in total where units can be argon atoms or CH₄ molecules, in a ratio determined by the percentage gas mixture. The beam was pulsed at 10 kHz with a 50% duty cycle and scanned over 64×64 pixels covering an area of 200×200 microns. The total ion fluence was 1.6e12 ions/cm².

Certain aspects of the disclosure are defined by the following paragraphs hereinafter.

An analytical method whereby a beam of ionized clusters formed from a gaseous mixture of a gas known to form clusters readily and one or more hydrogen-rich hydrocarbons is used to bombard a sample under vacuum either i) as a SIMS analysis beam, or ii) as a sputter beam during, or in rapid alternation with, bombardment by another beam that is acting as a SIMS analysis beam, or iii) as a dosing beam during, or in rapid alternation with, bombardment by another beam that is acting as a SIMS analysis beam, in order to produce an enhanced signal of secondary ions at the detector of a SIMS analyzer, thereby enhancing the chemical information obtained from the sample.

An analytical method as in disclosed herein wherein the hydrocarbon gas is methane, ethane, propane or butane.

An analytical method as in any of the aforementioned aspects, wherein the gas that readily forms clusters is helium, argon, neon, xenon, carbon dioxide or nitrogen.

An analytical method as in any of the aforementioned aspects, in which the beam of of ionized clusters can be selected to have a desired cluster size range (from 2 to 20,000) by tuning of the gas cluster source conditions, the ionizer conditions, a mass filter, or by a combination of these.

The analytical method as in any of the aforementioned aspects, in which the beam of ionized clusters is focused and rastered on the sample, allowing a spectral image of the secondary ions to be generated from the sample area being bombarded.

An analytical method as in any of the aforementioned aspects, in which the beam of ionized clusters is produced by expansion of the gas mixture from a region of higher pressure through a nozzle into a region of lower pressure (which is less than 1 mBar), then ionized and then accelerated to an energy in the range from 1 keV to 40 keV.

An analytical method as in any of the aforementioned aspects, in which the area being bombarded is repeatedly etched by the ionized cluster beam, eroding away the surface in layers, with the secondary ion data for each layer taken such that chemical information for different depths below the surface is acquired.

An analytical method as in any of the aforementioned aspects, in which the surface of the sample to be analyzed is bombarded with a beam of ionized clusters, the secondary ions produced by this not collected and then shortly afterwards, to benefit from the secondary ion yield enhancement resulting from protonation, a second ion beam of a different species is used to bombard part or all of the surface just bombarded by the ionized clusters and the ions generated by this second ion beam are collected and analyzed.

An analytical method as in any of the aforementioned aspects, in which the surface of the sample to be analyzed is bombarded with an ionized beam of clusters, the secondary ions produced collected and analyzed and then shortly afterwards, to benefit from the secondary ion yield enhancement resulting from protonation, a second ion beam of a different species is used to bombard part or all of the surface just bombarded by the ionized clusters and the secondary ions generated by this second ion beam are collected and analyzed.

An analytical method as in any of the aforementioned aspects, in which the surface of the sample to be analyzed is bombarded with a beam of ionized clusters with sufficiently low velocity component normal to the sample surface to produce no secondary ions, while simultaneously or in alternation, to benefit from secondary ion yield enhancement resulting from protonation, a second ion beam of a different species is used to bombard part or all of the surface just bombarded by the ionized clusters, and the secondary ions generated by this second ion beam collected and analyzed.

The analytical method as in any of the aforementioned aspects, in which the beam of ionized clusters is pulsed on/off during the analysis.

1. A mass spectrometer comprising:
means for producing a primary beam of ions for bombarding a sample under vacuum; and
a detector for detecting a secondary beam of ions released from the sample;
wherein the primary beam of ions includes a gaseous mixture of a cluster forming gas and one or more hydrogen-rich hydrocarbons.

2. The mass spectrometer of claim 1, wherein the one or more hydrogen-rich hydrocarbons is selected from methane, ethane, propane or butane.

3. The mass spectrometer of claim 1, wherein the cluster forming gas is selected from helium, argon, neon, xenon, carbon dioxide or nitrogen.

4. The mass spectrometer of claim 1, wherein the primary beam of ions contains between 2 and 20,000 molecules.

5. The mass spectrometer of claim 1, wherein the primary beam of ions is produced by adiabatic expansion of the gaseous mixture.

6. The mass spectrometer of claim 5, wherein the gaseous mixture is adiabatically expanded by passing from a high pressure region to a lower pressure region through a nozzle.

7. The mass spectrometer of claim 6, wherein the lower pressure region has a pressure of 1 mBar or less.

8. The mass spectrometer of claim 1, wherein the primary beam of ions are accelerated to an energy level between 1 keV and 40 keV prior to bombarding the sample.

9. The mass spectrometer of claim 1, further comprising means for producing an auxiliary beam of ions for bombarding the sample, where the auxiliary beam of ions comprises different species to those of the primary beam of ions.

10. The mass spectrometer of claim 9, wherein the primary beam of ions and the auxiliary beam of ions are arranged to simultaneously bombard the sample.

11. The mass spectrometer of claim 9, wherein the primary beam of ions and the auxiliary beam of ions are arranged to alternately bombard the sample.

12. The mass spectrometer of claim 9, wherein the detector is arranged to detect a secondary beam of ions released from the sample due to bombardment of the sample by the primary beam of ions.

13. The mass spectrometer of claim 9, wherein the detector is arranged to detect a secondary beam of ions released from the sample due to bombardment of the sample by the auxiliary beam.

14. The mass spectrometer of claim 9, further comprising a sampling device arranged to create pulses of the secondary beam of ions.

15. The mass spectrometer of claim 9, wherein the primary beam of ions is arranged to irradiate the sample.

16. The mass spectrometer of claim 9, wherein the primary beam of ions is arranged to deliver protons to the sample.

17. The mass spectrometer of claim 9, wherein the primary beam of ions is focused onto the sample with a spot size of 10 micrometres or less.

18. The mass spectrometer of claim 17, wherein the primary beam of ions is focused onto the sample with a spot size of 5 micrometres or less.

19. An analytical method, comprising:
bombarding a sample under vacuum using a primary beam of ionized clusters formed from a gaseous mixture of a gas known to form clusters readily and one or more hydrogen-rich hydrocarbons; and
producing an enhanced signal of secondary ions at the detector of a secondary ion mass spectrometry (SIMS) analyzer, thereby enhancing the chemical information obtained from the sample;
wherein the primary beam is used as a secondary ion mass (SIMS) analysis beam, a sputter beam during, or in rapid alternation with, bombardment by an auxiliary beam that is acting as a SIMS analysis beam, or as a dosing beam during, or in rapid alternation with, bombardment by an auxiliary beam that is acting as a SIMS analysis beam.

20. The analytical method of claim 19, further comprising selecting the one or more hydrogen-rich hydrocarbons from methane, ethane, propane or butane.

21. The analytical method of claim 19, further comprising selecting the gas known to form clusters from helium, argon, neon, xenon, carbon dioxide or nitrogen.

22. The analytical method of claim 19, wherein the primary beam of ionized clusters is selected to have a desired cluster size range between 2 and 20,000 molecules by tuning of one or more of gas cluster source conditions, ionizer conditions, or a mass filter.

23. The analytical method of claim 19, further comprising:
focusing and rastering the primary beam of ionized clusters on the sample; and
allowing a spectral image of the secondary ions to be generated from the sample area being bombarded.

24. The analytical method of claim 19, wherein the beam of ionized clusters is produced by expansion of the gaseous mixture from a region of higher pressure through a nozzle into a region of lower pressure which is less than 1 mBar, then ionized and then accelerated to an energy in the range from 1 keV to 40 keV.

25. The analytical method of claim 19, further comprising:
repeatedly etching the bombarded area by the ionized cluster beam; and
eroding away the surface in layers with the secondary ion data for each layer taken such that chemical information for different depths below the surface is acquired.

26. The analytical method of claim 19, wherein the auxiliary beam of ions comprises a different species to those of the primary beam.

27. The analytical method of claim 26, wherein secondary ions produced by bombardment of the sample with the primary beam are not collected, but secondary ions produced by bombardment of the sample with the auxiliary beam after bombardment of the sample with the primary beam are collected and analyzed.

28. The analytical method of claim 27, wherein the primary beam has a velocity component normal to a surface of the sample that is sufficiently low so as to produce substantially no secondary ions.

29. The analytical method of claim 26, wherein secondary ions produced by bombardment of the sample with the primary beam are collected and analyzed, and secondary ions produced by bombardment of the sample with the auxiliary beam after bombardment of the sample with the primary beam are also collected and analyzed.

30. The analytical method of claim 19, wherein the beam of ionized clusters is pulsed on/off during the analysis.
